(19) United States
(12) Patent Application Publication
(10) Pub. No.: US 2020/0070097 A1
(43) Pub. Date: Mar. 5, 2020

(54) METHOD OF WASHING HOLLOW FIBER MEMBRANE DEVICE, ULTRAFILTRATION MEMBRANE DEVICE, ULTRAPURE WATER PRODUCTION SYSTEM, AND WASHING DEVICE FOR HOLLOW FIBER MEMBRANE DEVICE

(71) Applicant: ORGANO CORPORATION, Tokyo (JP)

(72) Inventors: Fumitaka ICHIHARA, Tokyo (JP); Hiroshi SUGAWARA, Tokyo (JP)

(73) Assignee: ORGANO CORPORATION, Tokyo (JP)

(21) Appl. No.: 16/491,975

(22) PCT Filed: Feb. 8, 2018
(86) PCT No.: PCT/JP2018/004394

§ 371 Date: Sep. 6, 2019

(30) Foreign Application Priority Data
Mar. 9, 2017 (JP) 2017-044837

(51) Int. Cl. B01D 65/02; C02F 1/44; B01D 69/08

(52) U.S. Cl. CPC B01D 65/02; C02F 1/444; B01D 2321/28; B01D 2321/164; B01D 69/08

(57) ABSTRACT

Provided is a method of washing a hollow fiber membrane device which can efficiently remove fine particles while limiting the impact of an ultrapure water production system on the starting time. The method of washing a hollow fiber membrane device includes washing a hollow fiber membrane device with an alkaline aqueous solution before the hollow fiber membrane device is installed in an ultrapure water production system. The hollow fiber membrane device is washed by means of a washing device that is different from the ultrapure water production system.

### TECHNICAL FIELD

The present application is based upon and claims priority from Japanese Patent Application No. 201744837 filed on Mar. 9, 2017, the disclosure of which is hereby incorporated by reference herein in its entirety.

The present invention relates to a method of washing a hollow fiber membrane device, an ultrafiltration membrane device, an ultrapure water production system and a washing device for a hollow fiber membrane device, particularly to a method of washing an ultrafiltration membrane device that is installed in an ultrapure water production system that produces ultrapure water used in the manufacturing processes of electronic components, such as semiconductors.

### BACKGROUND ART

A hollow fiber membrane device, such as an ultrafiltration membrane device, is installed at the end of an ultrapure water production system in order to remove fine particles. Hollow fiber membranes can be installed with higher density than flat membranes and pleated membranes, and can increase the volume of permeating water per module. In addition, hollow fiber membrane devices can be easily manufactured while keeping the devices in a highly clean condition. Shipment, installation in an ultrapure water production system and on-site replacement can also be performed while keeping them in a highly clean condition. In other words, a hollow fiber membrane device is easy to manacle the level of cleanliness.

As the requirement of the water quality of ultrapure water has become strict, the requirement of ultrafiltration membrane devices also has become strict. In addition, ultrapure water production systems are required to start in a short time. Thus, a method has been proposed, in which a hollow fiber membrane device is washed in advance. JP2004-66015 discloses washing an ultrafiltration membrane device that is installed in an ultrapure water production system by means of a dedicated washing device. The ultrafiltration membrane device is washed by repeating a washing cycle that consists of the step of feeding ultrapure water, the step of immersion using the ultrapure water and the step of discharging the ultrapure water.

JP3896788 discloses a method of removing fine particles that adhere to a pipe and the like of an ultrapure water production system. Basic compounds, such as ammonia and sodium hydroxide, are added to ultrapure water that flows in the ultrapure water production system in order to adjust the pH of the ultrapure water between 7 and 14. Polyvinyl chloride (PVC) and polyphenylene sulfide (PPS), which are materials for pipes, have negative surface potential. Because fine particles are negatively charged by adjusting the pH of the ultrapure water toward alkalinity, the fine particles are detached from the surface of the pipe due to electrical force of repulsion.

### SUMMARY OF INVENTION

### Technical Problem

According to the method described in JP2004-66015, an ultrafiltration membrane device is washed with ultrapure water, but it takes a long time to wash because of the poor washing performance of ultrapure water. Among ultrafiltration membrane devices, an ultrafiltration membrane device that is capable of capturing fine particles having significantly small particle diameters (e.g., particle diameters of the order of 10 nm) needs a still longer time for washing due to the limited amount of water permeation. In addition, the requirement of the number of fine particles may not be satisfied even after it is washed for a long time. Meanwhile, according to the method described in JP3896788, alkaline washing is performed after an ultrafiltration membrane device is installed in an ultrapure water production system. Thus, the ultrafiltration membrane may be contaminated, degraded or broken due to eluted substances from pipes and system or due to operations. In addition, the washing takes time because the concentration of basic compound in the ultrapure water production system must be lowered to or below a predetermined value. In order to avoid this, the ultrafiltration membrane device may be bypassed during washing, but, in that case, a bypass pipe is required.

The present invention aims at providing a method of washing a hollow fiber membrane device which can efficiently remove fine particles while limiting the impact of an ultrapure water production system on the starting time.

The method of washing a hollow fiber membrane device according to the present invention comprises washing a hollow fiber membrane device with an alkaline aqueous solution before the hollow fiber membrane device is installed in an ultrapure water production system. The hollow fiber membrane device is washed by means of a washing device that is different from the ultrapure water production system.

According to the method of washing a hollow fiber membrane device of the present invention, the hollow fiber membrane device is washed with an alkaline aqueous solution. Therefore, fine particles can be efficiently removed. The hollow fiber membrane device is washed by a washing device that is different from the ultrapure water production system. Therefore, the ultrapure water production system can be started shortly after the hollow fiber membrane device that was washed is installed in the ultrapure water production system. Thus, according to the present invention, it is possible to provide a method of washing a hollow fiber membrane device which can efficiently remove fine particles while limiting the impact of an ultrapure water production system on the starting time.

The above-described and other objects, features, and advantages of this application will become apparent from the following detailed description with reference to the accompanying drawings that illustrate the present application.

### BRIEF DESCRIPTION OF DRAWINGS

FIG. 1 is a schematic diagram of the configuration of an ultrapure water production system;

FIG. 2 is a schematic diagram of the configuration of an ultrafiltration membrane device; and.

FIG. 3 is a schematic diagram of the configuration of a washing device for an ultrafiltration membrane device.

### LIST OF REFERENCE NUMERALS

1: ultrapure water production system
10: ultrafiltration membrane device
12: housing
13: hollow fiber membrane
21: washing device
22: washing water supply line
23: first outlet line
24: second outlet line
25: supply unit for ultrapure water
26: supply unit for alkaline washing agent
28 to 31: first to fourth valves
32: particle counter
33: conductivity meter

### DESCRIPTION OF EMBODIMENTS

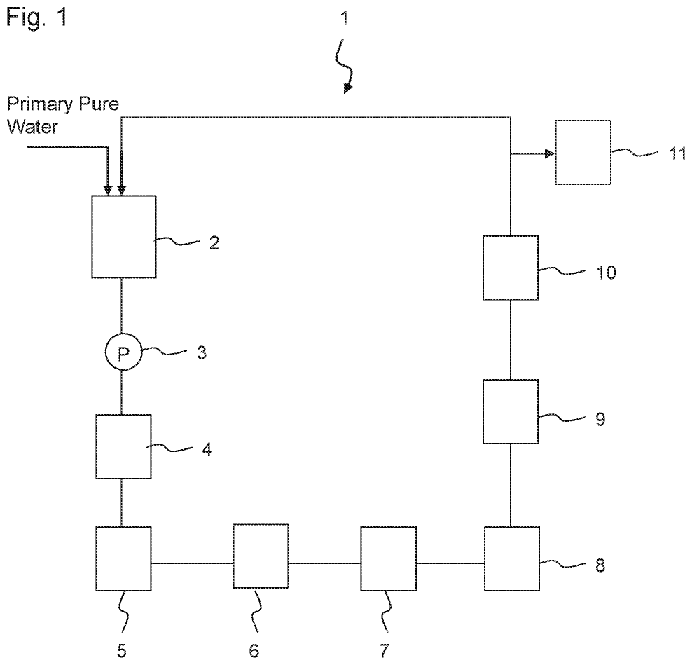

Embodiments of the present invention will be described hereinbelow with reference to the drawings. FIG. 1 illustrates an exemplary configuration of ultrapure water production system 1, to which the present invention is applied. Ultrapure water production system 1 includes primary pure water tank 2, pump 3, heat exchanger 4, ultraviolet oxidation device 5, hydrogenation device 6, catalytic reaction device 7, non-regenerative mixed bed ion exchange device (cartridge polisher) 8, membrane degassing device 9 and ultrafiltration membrane device 10. These components constitute a secondary pure water system (subsystem), which performs a series of processes on primary pure water that is produced by a primary pure water system (not shown) in order to produce ultrapure water, and supplies the ultrapure water to point of use 11.

Water to be treated (primary pure water) that is stored in primary pure water tank 2 is fed by pump 3 and is supplied to heat exchanger 4. The water to be treated that passes through heat exchanger 4, where the temperature is adjusted, is supplied to ultraviolet oxidation device 5. The water to be treated is irradiated with ultraviolet rays at ultraviolet oxidation device 5 in order to decompose total organic carbon (TOC) in the water to be treated. Hydrogen is added to the water to be treated at hydrogenation device 6, and oxidizing substances in the water to be treated are removed at oxidizing substance removal device 7. Further, metallic ions and the like in the water to be treated are removed in an ion exchange process at cartridge polisher 8, and remaining oxidizing substances (oxygen) are removed at membrane degassing device 9. Fine particles in the water to be treated are then removed at ultrafiltration membrane device 10. Part of the ultrapure water thus obtained is supplied to point of use 11 and the remainder thereof flows back to primary pure water tank 2. Primary pure water is supplied to primary pure water tank 2 from a primary pure water system (not shown), as needed.

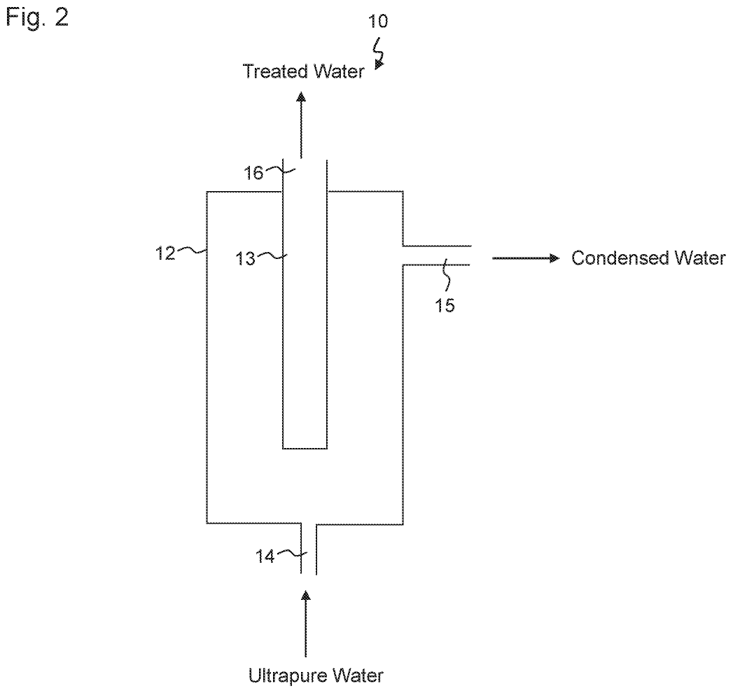

FIG. 2 illustrates an exemplary conceptual diagram of ultrafiltration membrane device 10. Ultrafiltration membrane device 10 has housing 12 and a plurality of hollow fiber membranes 13 that are accommodated in housing 12. In the figure, only one hollow fiber membrane 13 is shown. Housing 12 and hollow fiber membranes 13 are provided in the form of a module, and ultrafiltration membrane device 10 is also called an ultrafiltration membrane module. Housing 12 includes inlet 14 for water to be treated and outlet 15 for concentrated water, both of which are in communication with the internal space of housing 12 (except for the internal space of hollow fiber membrane 13), and outlet 16 for treated water that is in communication with the internal space of hollow fiber membrane 13. The concentrated water is ultrapure water whose density of fine particles (fine particles per milliliter) is increased by the fine particles that do not permeate through hollow fiber membrane 13. The water to be treated (ultrapure water) that flows into housing 12 via inlet 14 for water to be treated permeates through hollow fiber membrane 13 from outside to inside. Fine particles that are contained in the water to be treated remain outside of hollow fiber membrane 13 because they cannot pass through hollow fiber membrane 13, and the fine particles are discharged from outlet 15 of housing 12 for concentrated water. The treated water free of fine particles is discharged through outlet 16 for treated water. The system in which water to be treated permeates through hollow fiber membrane 13 from outside to inside is called an external pressure system. An internal pressure system, in which water to be treated permeates through hollow fiber membrane 13 from inside to outside may also be used. However, because it is easy to keep the internal space of hollow fiber membrane 13 clean in the manufacturing processes, the external pressure system is preferable as ultrafiltration membrane device 10 that is installed at the end of ultrapure water production system 1 from the standpoint of obtaining treated water having better quality. It should be noted that the configuration of ultrafiltration membrane device 10 illustrated in FIG. 2 is merely an example and that configurations different from that illustrated in FIG. 2 are also applicable. Examples of ultrafiltration membrane devices 10 include an ultrafiltration membrane module having a hollow fiber membrane that is made of polysulfone and that has a cutoff molecular weight of 6000 (e.g., NTU-3306-K6R manufactured by Ditto Denko Corporation and OLT-6036H manufactured by Asahi Kasei Corporation).

Eluted substances from ultrafiltration membrane device 10 include fine particles that are generated by ultrafiltration membrane device 10 itself during the manufacturing process and that adhere to ultrafiltration membrane device 10. Accordingly, in the present embodiment, fine particles that adhere to ultrafiltration membrane device 10 are removed by means of a dedicated washing device that is different from ultrapure water production system 1 before ultrafiltration membrane device 10 is installed in ultrapure water production system 1.

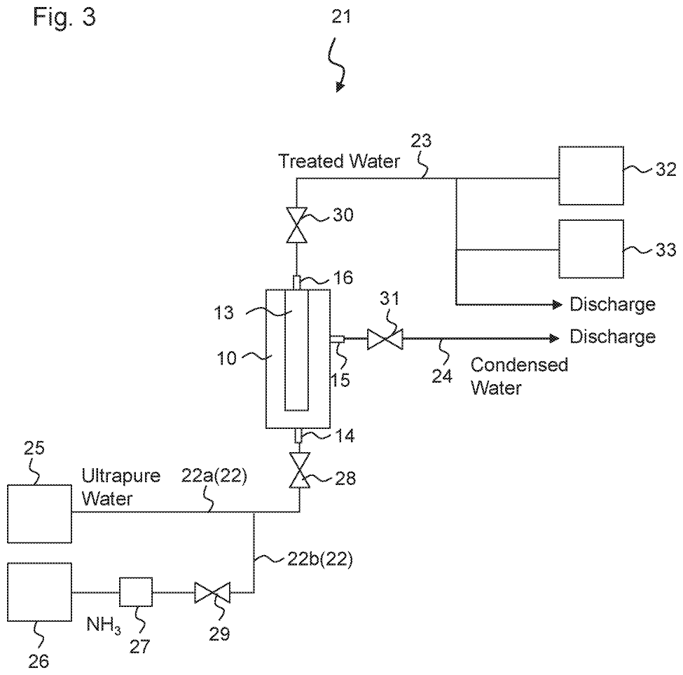

FIG. 3 illustrates a schematic configuration of washing device 21 for ultrafiltration membrane device 10. Washing device 21 has washing water supply line 22 that is connected to inlet 14 of ultrafiltration membrane device 10 for water to be treated, first outlet line 23 for washing water that is connected to outlet 16 of ultrafiltration membrane device 10 for treated water, second outlet line 24 for the washing water that is connected to outlet 15 of ultrafiltration membrane device 10 for concentrated water, supply unit 25 for ultrapure water and supply unit 26 for an alkaline washing agent, both of which are connected to supply line 22. Washing water supply line 22 includes first supply line 22a that connects supply unit 25 for ultrapure water to inlet 14 of ultrafiltration membrane device 10 for water to be treated, as well as second supply line 22b that connects supply unit 26 for an alkaline washing agent with first supply line 22a. Second supply line 22b has microfiltration membrane 27 for removing foreign substances that are contained in the alkaline washing agent. First supply line 22a has first valve 28, second supply line 22b has second valve 29, first outlet line 23 has third valve 30, and second outlet line 24 has fourth valve 31. Second valve 29 constitutes control means that controls the supply of the alkaline washing agent (whether or not it supplies the agent, and a flow rate). Instead of providing the second valve, it is also possible to provide a pump, which feeds the alkaline washing agent, on second supply line 22b. Washing device 21 further includes particle counter 32 and conductivity meter 33, each provided on a line that branches from first outlet line 23. The waste water that is discharged from first outlet line 23 and second outlet line 24 is disposed of without being reused.

Next, the method of washing ultrafiltration membrane device 10 by means of above-described washing device 21 will be described. First, ultrafiltration membrane device 10 is installed in washing device 21 Specifically, inlet 14 of ultrafiltration membrane device 10 for water to be treated is connected to washing water supply line 22; outlet 16 of ultrafiltration membrane device 10 for treated water is connected to first outlet line 23; and outlet 15 of ultrafiltration membrane device 10 for concentrated water is connected to second outlet line 24. Subsequently, first to fourth valves 28 to 31 are opened. Ultrapure water is supplied from first supply line 22a, and the alkaline washing agent is supplied from second supply line 22b. An alkaline aqueous solution, which is generated by mixing the ultrapure water with the alkaline washing agent, is supplied to ultrafiltration membrane device 10. Ultrapure water may be fed through ultrafiltration membrane device 10 before the alkaline aqueous solution is supplied to ultrafiltration membrane device 10. By doing so, fine particles that adhere to ultrafiltration membrane device 10 are removed to some extent, and variation in the conditions of ultrafiltration membrane device 10 before it is washed with the alkaline aqueous solution can be reduced. Thus, the criterion for evaluating the effect of washing the device with the alkaline aqueous solution is clarified, and the reliability of the evaluation is enhanced.

The alkaline aqueous solution continues to be fed until the concentration of the alkaline washing agent is stabilized at a predetermined value, while measuring the concentration of the alkaline washing agent in the alkaline aqueous solution by means of conductivity meter 33 and while adjusting the degree of opening of second valve 29 (or the flow rate of the above-described pump). When the concentration of the alkaline washing agent is stabilized, the alkaline aqueous solution is further fed for a predetermined time (e.g., several minutes). Subsequently, first to fourth valves 28 to 31 are closed, and hollow fiber membrane 13 of ultrafiltration membrane device 10 is immersed in the alkaline aqueous solution. In other words, ultrafiltration membrane device 10 is isolated from the surroundings, and the inner space of ultrafiltration membrane device 10 is filled with the alkaline aqueous solution.

Components of ultrafiltration membrane device 10, such as housing 12, hollow fiber membrane 13 and an adhesive for bonding hollow fiber membrane 13 to housing 12, are formed of polymeric materials. Therefore, treated water contains organic fine particles and TOC components. In general, fine particles made of polymeric materials have a negative surface electrical charge (zeta potential) in water. Polysulfone and epoxy resin, which are the main components of ultrafiltration membrane device 10, have negative surface electrical charges in water, and fine particles thereof exhibit larger negative surface electrical charges in an alkaline aqueous solution. The components of ultrafiltration membrane device 10 and many fine particles in ultrafiltration membrane device 10 are formed of the same material, and they have a surface electrical charge of the same sign (i.e., a negative surface electrical charge) in water. The absolute value of the surface electrical charge increases in an alkaline aqueous solution, and thereby the electrical force of repulsion further increases. Fine particles that adhere to ultrafiltration membrane device 10 are detached from ultrafiltration membrane device 10 due to this electrical force of repulsion.

Because the alkaline aqueous solution is fed through ultrafiltration membrane device 10 first, the fine particles can be more easily detached from ultrafiltration membrane device 10 due to the flow of the alkaline aqueous solution. By immersing ultrafiltration membrane device 10 in the alkaline aqueous solution thereafter, the fine particles are more easily detached from ultrafiltration membrane device 10. The volume of alkaline aqueous solution consumed and discharged can be limited by immersion. Fine particles adhere to ultrafiltration membrane device 10 by intermolecular force (the van der Weals' force). However, it takes some time to detach the fine particles from ultrafiltration membrane device 10 against the intermolecular force because there is no flow of the alkaline aqueous solution during the immersion. Therefore, the immersion is preferably performed as long as possible. Instead of performing immersion for a long time, it is also possible to repeat feeding of the alkaline aqueous solution and immersion in the alkaline aqueous solution,

Regarding ultrafiltration membrane device 10, which is to be washed, high-quality devices have been conventionally provided, and fine particles that adhere to the device are limited. Thus, the need to use an alkaline solution having a high concentration and a high pH is small. The alkaline aqueous solution preferably has a pH of 8 to 11, more preferably 9 to 10. Ammonia (NH₃), amine, tetraalkylammonium hydroxide (TMAH), choline, etc. may be used as an alkaline washing agent that is to be added to ultrapure water to create an alkaline aqueous solution. In addition, metal concentration, as well as the number of fine particles, is strictly managed in ultrapure water production system 1. Therefore, it is preferable to limit as much as possible the amount of metal components that are contained in the alkaline aqueous solution. Accordingly, it is preferable to use a washing liquid that is obtained by diluting amine, ammonia or TMAH of high purity EL grade having low metal content and particle content, with ultrapure water. Aqueous ammonia solution is preferably used in terms of cost, treatment of discharged water and reduction of environmental load.

After that, first, third, and fourth valves 28, 30, 31 are opened again, and ultrapure water is fed in order to rinse ultrafiltration membrane device 10. Second valve 29 remains closed. Fine particles that are detached from ultrafiltration membrane device 10 are discharged to the outside of ultrafiltration membrane device 10 by the flow of the ultrapure water. TOC components are discharged in the same manner. In addition, the alkaline aqueous solution that adheres to ultrafiltration membrane device 10 is also removed. After that, the number of fine particles (particles/mL) is counted by means of particle counter 32, as needed.

Ultrapure water used for the rinsing preferably has an electrical resistivity of 18 MΩcm or more, and a metal concentration of 10 ppt or less, more preferably an electrical resistivity of 18.2 MΩcm or more and a metal concentration of 1 ppt or less. Since ultrafiltration membrane device 10 cannot remove ion components and metals, it does not contribute to the improvement of the electrical resistivity and the metal concentration. Thus, in order to secure the quality of ultrapure water that is produced by ultrapure water production system 1, rinsing is preferably performed until the electrical resistivity and the metal concentration on the secondary side (downstream side) of uitrafiltration membrane device 10 matches those on the primary side (upstream side). Meanwhile, the number of fine particles in the ultrapure water used for the rinsing has a small impact on the rinsing. This is because, according to the washing method of the present embodiment, the fine particles that adhere to ultrafiltration membrane device 10 on the secondary side are removed, and most of the fine particles on the primary side do not permeate through hollow fiber membrane 13. However, in order to reduce the risk of fine particles on the primary side permeating through hollow fiber membrane 13 and to secure the quality of ultrapure water that is produced by ultrapure water production system 1, the number of fine particles having particle diameters of 50 nm or more in the ultrapure water used for rinsing is preferably 1/mL or less. In addition, an alkaline aqueous solution has the effect of reducing TOC because it removes low molecular weight soluble organic substances, as well as high molecular fine particles. However, in order to secure the quality of ultrapure water that is produced by ultrapure water production system 1, TOC in ultrapure water used for the rinsing is preferably 5 ppb or less, more preferably 1 ppb or less.

Ultrafiltration membrane device 10, from which fine particles were removed in the above-described steps, is removed from washing device 21, and is installed at a predetermined position of ultrapure water production system 1. Since ultrafiltration membrane device 10 is in a clean state, production of ultrapure water can be immediately started after performing preparatory operations for a short time, as needed.

In the washing, it is further preferable to perform the feeding of the alkaline aqueous solution after the immersion is completed and before the rinsing with ultrapure water is performed. Fine particles that were once detached from ultrafiltration membrane device 10 may adhere to ultrafiltration membrane device 10 again by, the intermolecular force. In particular, when ultrapure water is fed after the immersion, pH of the surrounding water tends to be neutral, the electrical force of repulsion acting between the fine particles and ultrafiltration membrane device 10 decreases, and fine particles tend to adhere to ultrafiltration membrane device 10 again. By feeding alkaline aqueous solution in advance, fine particles can be discharged to the outside of ultrafiltration membrane device 10 by the flow of the alkaline aqueous solution while maintaining the electrical force of repulsion. As a result, fine particles that remain in ultrafiltration membrane device 10 can be further reduced.

In the above-described embodiment, the following two patterns have been explained:
(1) Feeding alkaline aqueous solution->immersion in the alkaline aqueous solution->rinsing with ultrapure water
(2) Feeding alkaline aqueous solution->immersion in the alkaline aqueous solution->feeding alkaline aqueous solution->rinsing with ultrapure water
(As discussed above, it is also possible to feed ultrapure water before feeding the alkaline aqueous solution.).

However, the washing method of the present invention is not limited to these patterns. For example, instead of immersion, it is possible to continue to feed alkaline aqueous solution for a long time. Although a larger amount of alkaline aqueous solution is discharged, this pattern is more effective in reducing fine particles. In this case, it is also possible to feed alkaline aqueous solution at a large flow rate first and to continue to feed alkaline aqueous solution while gradually decreasing the flow rate. Further, these steps may be repeated. While the alkaline aqueous solution discharged is disposed of in the above-described embodiment, the aqueous solution may be recycled (reused) after it is filtered by a filter. The types (immersion or feeding for a long time) and conditions (pH, concentration and temperature of the alkaline aqueous solution, time of immersion) of the washing can be determined, as appropriate, taking into account the conditions of ultrafiltration membrane device 10 to be washed, the conditions of ultrafiltration membrane device 10 that are required after the washing (quality requirements of ultrapure water), limitation of the amount of alkaline aqueous solution used or discharged, and so on.

In addition, although the present embodiment is directed to an ultrafiltration membrane device that is installed at the most downstream stage of an ultrapure water production system, the present invention may be used for washing of and evaluating the level of cleanliness of any hollow fiber membrane device, such as an ultrafiltration membrane device of different types and a microfiltration membrane device. Furthermore, while the present embodiment is directed to a new ultrafiltration membrane device, the present invention may also be used for washing of or regeneration of a used hollow fiber membrane device.

### EXAMPLES

Ultrafiltration membrane device 10 was washed by means of the device illustrated in FIG. 3. As shown in Table 1, ammonia water was used as the alkaline aqueous solution in Examples 1 and 2, and only ultrapure water was fed in the comparative example. In Examples 1 and 2, ammonia water was fed and ammonia immersion was performed. It was confirmed from the measurement of a conductivity meter that the ammonia concentration had been stabilized. Then, ammonia water was fed for five minutes, and immersion by ammonia water was conducted for about half a day. In Example 2, ammonia water was fed after the immersion by, ammonia water was conducted. Then, it was confirmed from the measurement of a conductivity meter that the ammonia concentration had been stabilized. Then, ammonia water was fed for another five minutes. The number of fine particles was measured by means of a particle counter UDI-20 manufactured by Spectris Co., Ltd. The ammonia concentration was 11 to 12 mg/L, and the flow rate of ammonia water was 10 m³/L.

TABLE 1

| | | | | Comparative |
|---|---|---|---|---|
| | | Example 1 | Example 2 | Example |
| Step | | | | |
| NH₃ Feeding | | Conducted | Conducted | — |
| NH₃ Immersion | | Conducted | Conducted | — |
| NH₃ Feeding | | — | Conducted | — |
| Rinsing with ultrapure water | | Conducted | Conducted | Conducted |
| Result | | | | |
| A | Number of particles having | 0.16 | 0.06 | 0.43 |
| | particle diameters of 20 nm or | | | |
| | more (particles/mL) | | | |
| B | Upper limit of A | 0.89 | 0.42 | 1.68 |
| C | Number of particles having | 0.04 | 0.03 | 0.07 |
| | particle diameters of 50 nm or | | | |
| | more (particles/mL) | | | |
| D | Upper limit of C | 0.26 | 0.20 | 0.32 |

In the table, B represents the number of fine particles corresponding to +3σ (σ is the standard deviation) of measurement A, and D represents the number of fine particles corresponding to +3σ of measurement C. B and D serve as one of management values of the number of fine particles. From this, in the comparative example, a criterion for managing the number of fine particles having particle diameters of 20 nm or more is about 2/mL. In contrast, in Example 1, the criterion is about 1/mL. In Example 2, ammonia water was further fed after the immersing process using ammonia water was completed, and the number of fine particles further decreases. This enables the management to be conducted at the level of 0.5/mL or less.

Although some preferred embodiments of the present invention have been illustrated and described in detail, it should be appreciated that various changes and modifications can be made thereto without deviating from the spirit and the scope of the appended claims.

1. A method of washing a hollow fiber membrane device, the method comprising washing a hollow fiber membrane device with an alkaline aqueous solution before the hollow fiber membrane device is installed in an ultrapure water production system, wherein the hollowfiber membrane device is washed by means of a washing device that is different from the ultrapure water production system.

2. The method of washing the hollow fiber membrane device according to claim 1, wherein the hollow fiber membrane device is rinsed with ultrapure water after it is washed with the alkaline aqueous solution.

3. The method of washing the hollow fiber membrane device according to claim 2, wherein washing with the alkaline aqueous solution includes;
feeding the alkaline aqueous solution through the hollow fiber membrane device; and
thereafter immersing the hollow fiber membrane device in the alkaline aqueous solution before the hollow fiber membrane device is rinsed with the ultrapure water.

4. The method of washing the hollow fiber membrane device according to claim 2, wherein the ultrapure water has an electrical resistivity of 18 MΩcm or more and TOC of 5 ppb or less, a number of fine particles having particle diameters of 50 nm or more in the ultrapure water is 1/mL or less, and metal concentration in the ultrapure water is 10 ppt or less.

5. The method of washing the hollow fiber membrane device according to claim 1, wherein pH of the alkaline aqueous solution is 8 to 11.

6. The method of washing the hollow fiber membrane evice according to claim 1, wherein the alkaline aqueous solution is an aqueous ammonia solution, an aqueous amine solution or an aqueous tetraalkylammonium hydroxide solution.

7. The method of washing the hollow fiber membrane device according to claim 1, wherein the hollow fiber membrane device is an ultrafiltration membrane device that is installed at a most downstream stage of an ultrapure water production system.

8. An ultrafiltration membrane device that is installed in an ultrapure water production system, the ultrafiltration membrane device comprising:
a housing;
a hollow fiber membrane that is accommodated in the housing;
an inlet for water to be treated that is formed on the housing and that is in communication with an internal space of the housing; and
an outlet for treated water that is formed on the housing and that is in communication with an internal space of the hollow fiber membrane,
wherein number of fine particles having particle diameters of 20 nm or more that are contained in treated water is 0.5/mL or less, wherein the treated water is obtained at the outlet for the treated water by supplying ultrapure water at the inlet for the water to be treated.

9. An ultrapure water production system comprising:
an ion exchange device; and
the ultrafiltration membrane device according to claim 8, wherein the ultrafiltration membrane device is arranged downstream of the ion exchange device.

10. A washing device for a hollow fiber membrane device, wherein the hollow fiber membrane device includes a housing and a hollow fiber membrane that is accommodated in the housing, the washing device comprising:
a supply line for washing water that is connected to an inlet for water to be treated, wherein the inlet is in communication with an internal space of the housing;
a first outlet line for the washing water that is connected to an outlet for treated water, wherein the outlet for water to be treated is in communication with an internal space of the hollow fiber membrane;
a second outlet line for the washing water that is connected to an outlet for concentrated water, wherein the outlet for concentrated water is in communication with the internal space of the housing;
a supply unit for ultrapure water that is connected to the supply line;
a supply unit for alkaline washing agent that is connected to the supply line; and
control means that controls supply of the alkaline washing agent.
